(19) United States
(12) Patent Application Publication
(10) Pub. No.: US 2005/0223307 A1
(43) Pub. Date: Oct. 6, 2005

(54) Computer system for executing multimedia player system and the method thereof

(76) Inventors: Tung-Peng Wu, Taipei (TW); Chi-Min Liu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/078,343

(22) Filed: Mar. 14, 2005

(30) Foreign Application Priority Data
Mar. 17, 2004 (TW) 093107169

(51) Int. Cl. G06F 17/00; G06F 15/00

(52) U.S. Cl. 715/500

(57) ABSTRACT

A computer system for executing multimedia player system and the method thereof are disclosed. The computer system is installed with a first operating system and a second operating system with lower resource consumption than the first operating system. Users send a remote signal to initiate the extensible firmware interface and drive necessary hardware for executing multimedia player system though an input unit. Then judging whether the remote signal is for executing the multimedia player system, if yes, the second operating system and the multimedia player system are executed. If the remote signal is not for executing the multimedia player system, the first operating system is executed and all hardware of the computer system is driven. Thus users only need to operate the multimedia player system by sending a remote signal through the input unit and the initiating time of the computer system is reduced.

### BACKGROUND OF THE INVENTION

The present invention relates to a computer system for executing multimedia player system and the method thereof, especially to a computer system that makes users initiate the multimedia player system easily and conveniently

Due to economic recession, people lives in a highly competitive environment. Thus it is an important issue to relieve physical and emotional hardship. Most of people relax from the pressure by watching TV programs, movies and listening to music and most families has electronic products for playing compact disk (CD), digital versatile disc (DVD), and video compact disc (VCD). However, due to fast development of intelligence technology, the computer systems available now integrates data processing, wireless data transmission, internet with fax functions. Moreover, they are also disposed with a multimedia player system for entertainment such as displaying video data, playing music and broadcasting. Thus there is no need for people to buy new electronic products for entertainment. This is not only reduced the occupation of interior space but also the cost for electronic products.

While watching TV programs, listening to music or broadcasting by the multimedia player system, users need to input external instructions to execute the multimedia player system by a keyboard or mouse after the computer system being booted. Thus they need to wait for a period of time for booting the computer. As to users have no idea about computers, the process of initiating the multimedia player system is more complicated than general operation of home appliances such as television and audio equipment. Moreover, when the computer system is booted, entering the operating system, all hardware of peripherals is initiated at the same time. If users only want to user the multimedia player system, this causes waste of power. Moreover, due to the requirements for prevention of computer virus infection, system management and system stability, loadings and resources consumption of Windows operating system keep increasing. Even only a single application program is used, users still need to wait for a long time to turn on the computer system. This causes waste of time and low efficiency.

### SUMMARY OF THE INVENTION

It is therefore a primary object of the present invention to provide a computer system for executing multimedia player system and the method thereof by which users can initiate the multimedia player system easily and quickly so as to raise the convenience of usage of the computer system.

It is another object of the present invention to provide a computer system for executing multimedia player system and the method thereof that makes the computer system execute the multimedia player system under the operating system with low resource consumption so as to reduce the resource consumption of the computer system and shorten the initiating time of the multimedia player system. Thus the efficiency of the computer system is improved.

It is a further object of the present invention to provide a computer system for executing multimedia player system and the method thereof that only initiates necessary peripheral hardware for the multimedia player system so as to reduce the power consumption of the computer system.

In order to achieve above objects, the present invention provides a computer system for executing multimedia player system and the method thereof. The computer system is installed with a multimedia player system, a first operating system, and a second operating system with lower resource consumption than the first operating system. When users send a remote signal through an input unit of the computer system, a basic input output system is initiated. Then a first extensible firmware interface is also initiated to drive hardware equipment of the computer system necessary for execution of the multimedia player system. Whether the remote signal is for executing the multimedia player system is judged by the basic input output system or the first extensible firmware interface. If the remote signal is for executing the multimedia player system, the second operating system and the multimedia player system are executed. If not, a second extensible firmware interface of the computer system is initiated, the first operating system is executed and all hardware equipment of the computer system is turned on.

Moreover, the first extensible firmware interface and the second extensible firmware interface are capable of being integrated into one extensible firmware interface. Furthermore, the present invention can also have no basic input output system. After a remote signal is sending by users, the first extensible firmware interface or the integrated extensible firmware interface is initiated directly, instead of the basic input output system.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of an embodiment in accordance with the present invention;

FIG. 2 is a flow chart of an embodiment in accordance with the present invention;

FIG. 3 is a block diagram of another embodiment in accordance with the present invention;

FIG. 4 is a flow chart of another embodiment in accordance with the present invention;

FIG. 5 is a block diagram of a further embodiment in accordance with the present invention;

FIG. 6 is a flow chart of a further embodiment in accordance with the present invention;

FIG. 7 is a block diagram of a further embodiment in accordance with the present invention;

FIG. 8 is a flow chart of a further embodiment in accordance with the present invention.

### DETAILED DESCRIPTION OF THE PREFFERED EMBODIMENT

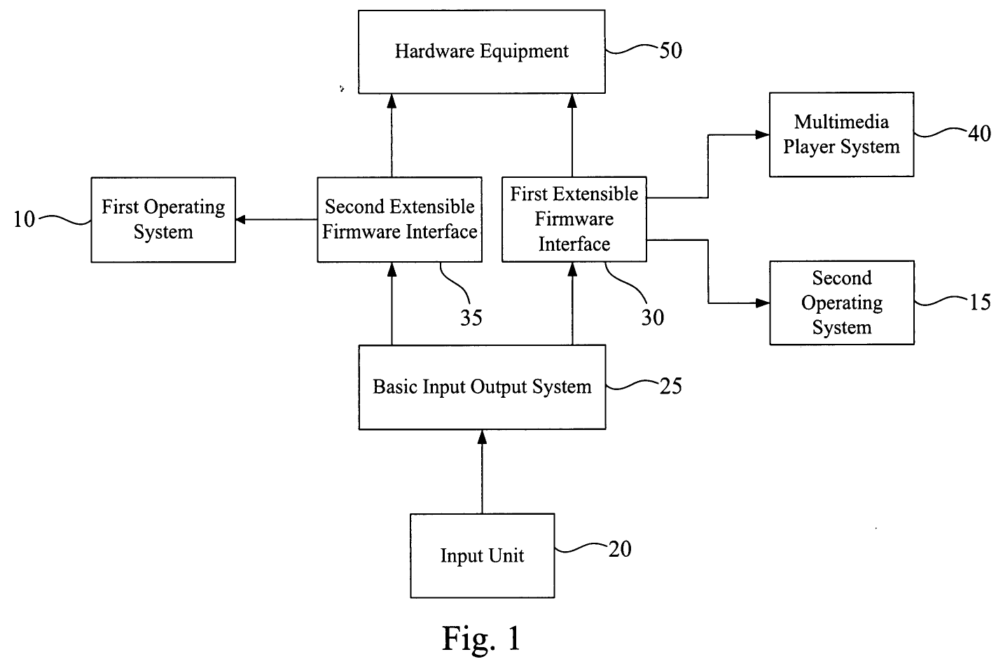

Refer to FIG. 1, a computer system in accordance with the present invention is installed with a first operating system 10 and a second operating system 15. The first operating system 10 is an operating system installed with at least one application program and having higher system resource consumption such as a Windows operating system—Windows XP, Windows NT, Window 98, Windows 2000 and Windows Me. The second operating system 15 is an operating system with lower system resource consumption than the first operating system 10 such as Linux operating system. The second operating system 15 shares data of the first operating system 10 with the first operating system 10.

The computer system includes an input unit 20 such as a remote controller for sending out a remote signal by users to boot up the computer system for executing a multimedia player system 40; the remote signal transmitted from the input unit 20 initiates a basic input output system (BIOS) 25 of the computer system for driving a first extensible firmware interface (EFI) 30. When the first extensible firmware interface 30 is initiated, a plurality of hardware equipment 50 necessary for the execution of the multimedia player system 40 is also driven. The multimedia player system 40 is used to play audio/video data such as MPEG-1 Audio Layer 3 (MP3) music, compact disk (CD), digital versatile disc (DVD), Video Compact Disc (VCD), television programs, broadcasting and digital photographs. While executing multimedia functions, the necessary hardware equipment 50 such as optical disk drives, hard disks, transmission control devices (IDE ATA/ATAPI), video processing devices, audio processing devices, amplifiers and speakers are also need to be turned on.

If the remote signal sent from the input unit 20 is a signal for executing the multimedia player system 40, the second operating system 15 and the multimedia player system 40 are executed after the remote signal initiating the basic input output system 25 as well as the first extensible firmware interface 30 and then driving the hardware equipment 50 necessary for executing the multimedia player system 40. The multimedia player system 40 is executed under the second operating system 15. Due to lower system resource consumption of the second operating system 15 than the first operating system 10, the speed for initiating the second operating system 15 is faster than that of the first operating system 10 so that the multimedia player system 40 is executed more quickly and the efficiency is improved. If the emote signal is not for executing the multimedia player system 40, a second extensible firmware interface 35 of the computer system is initiated, the first operating system 10 is executed, and all hardware equipment 50 of the computer system is driven so as to boot up the computer system normally.

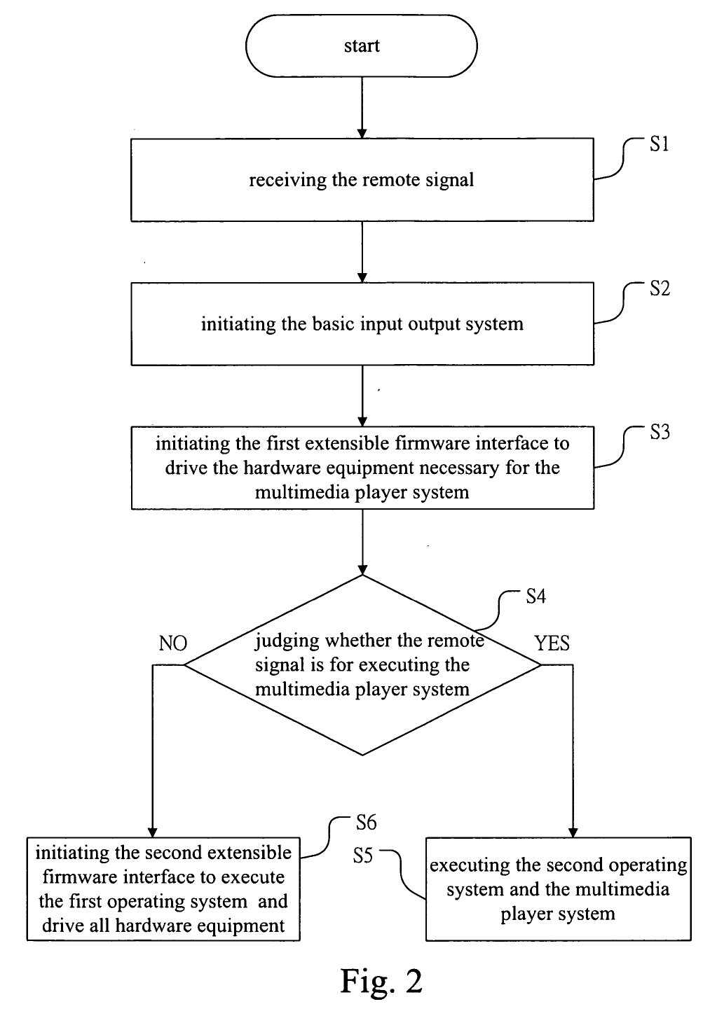

Refer to FIG. 2, when users intend to boot up the computer system, or only want to execute the multimedia player system 40 for displaying audio/video data, they only need to press the input unit 20 for sending out a remote signal. As shown in step S1, the computer system receives the remote signal, and then initiates the basic input output system 25, as shown in step S2. Refer to step S3, the first extensible firmware interface 30 is initiated and the hardware equipment 50 necessary for the multimedia player system 40 are driven. Refer to step S4, judge whether the remote signal is for executing the multimedia player system 40 by the first extensible firmware interface 30 or the basic input output system 25.

If the remote signal is for executing the multimedia player system 40, then refer to step S5, the second operating system 15 and the multimedia player system 40 are executed by the basic input output system 25 or the first extensible firmware interface 30. Thus users only need to press a button for operating the multimedia player system 40 easily. On the contrary, the conventional way to execute the multimedia player system 40 is to enter an operating system with higher system resource consumption firstly and then click on the elections on windows. Also all hardware equipment of the computer system is activated so that the power is consumed. If the remote signal is not for executing the multimedia player system 40, then refer to step S6, the second extensible firmware interface 35 is initiated, the first operating system 10 is executed and all hardware equipment 50 of the computer system is driven. The second extensible firmware interface 35 is initiated by the basic input output system 25 or the first extensible firmware interface 30 while the first operating system 10 is executed by the basic input output system 25. The first extensible firmware interface 30 and the second extensible firmware interface 35 in accordance with the present invention take graphical user interface for the convenience of users' operation, installation of hardware equipment, addition of new hardware equipment and change of the settings.

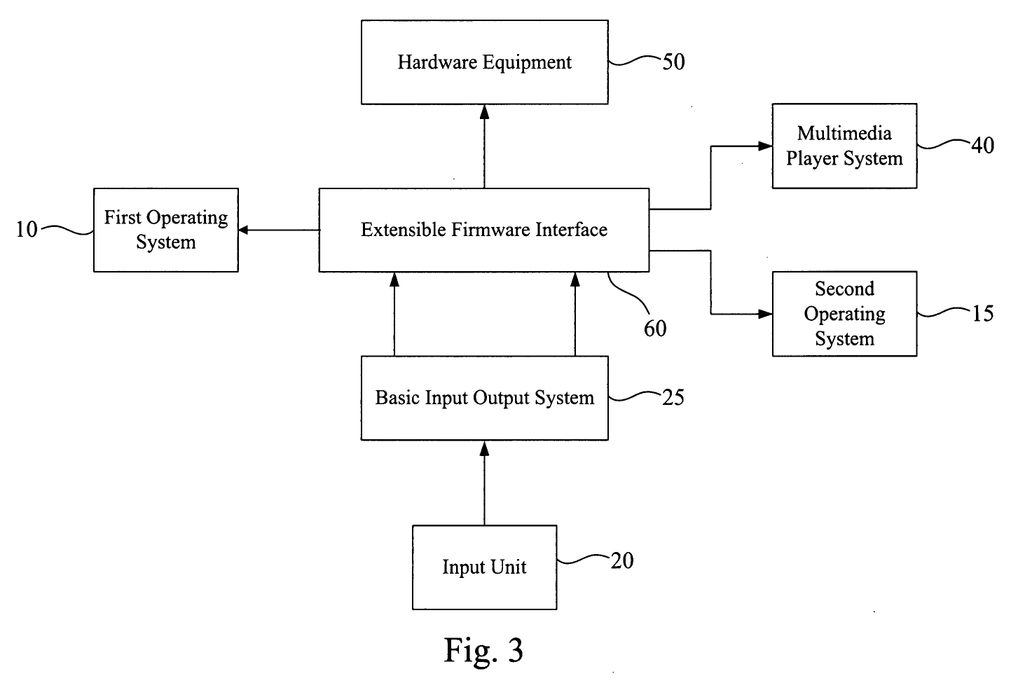

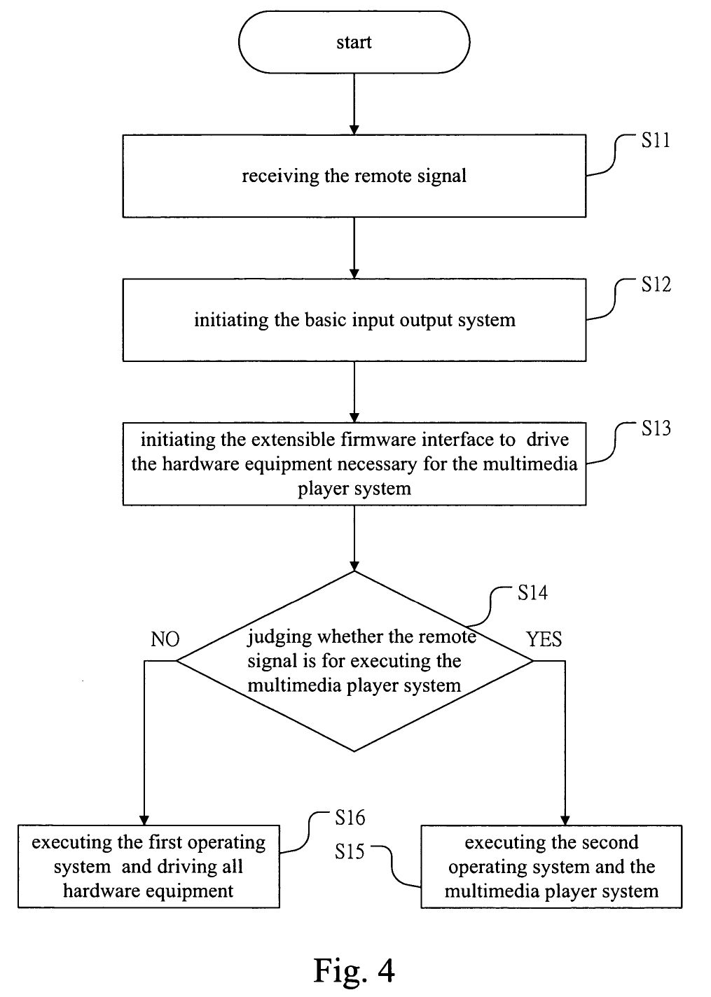

Refer to FIG. 3 & FIG. 4, another embodiment of the present invention is disclosed. The difference between this embodiment and above embodiment is in that the first extensible firmware interface 30 and the second extensible firmware interface 35 are integrated into one extensible firmware interface 60. In the flow chart, refer to step S14, after judging whether the remote signal is for executing the multimedia player system 40, if the answer is no, continue step S16. The first operating system 10 is executed and the all hardware equipment 50 is driven through the extensible firmware interface 60.

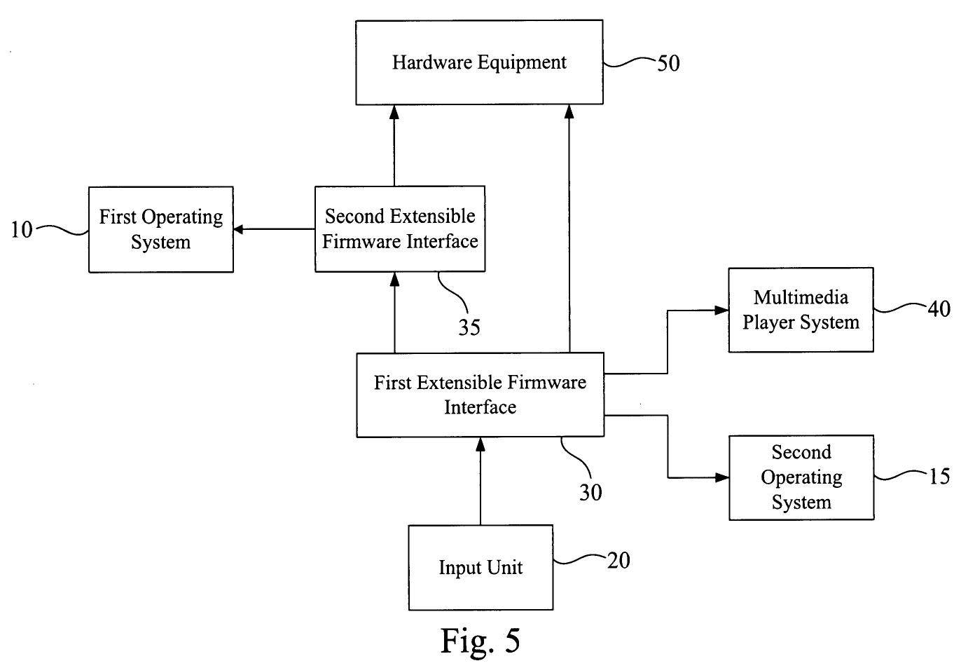

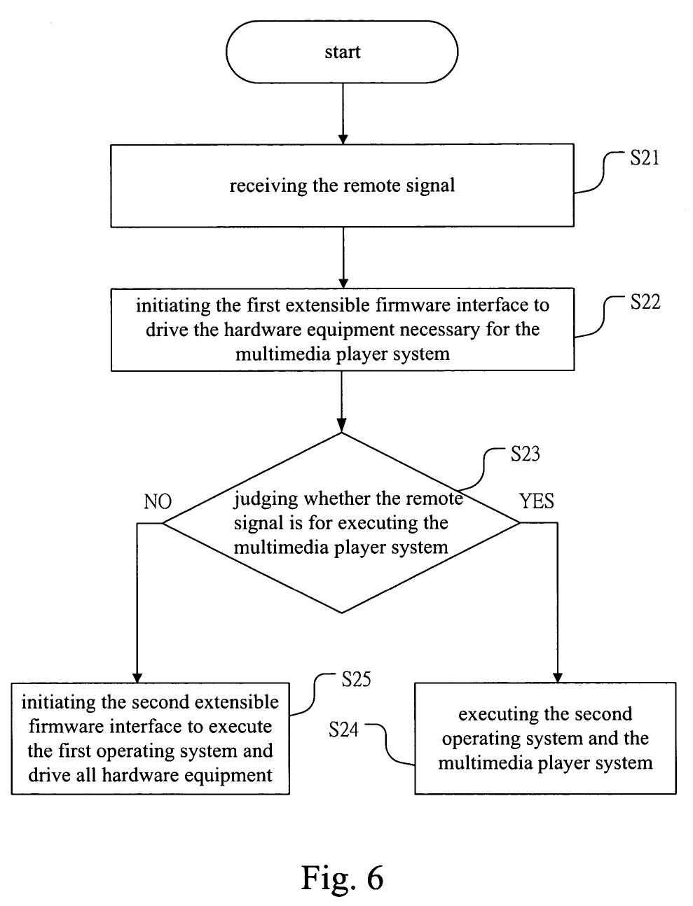

Refer to FIG. 5 & FIG. 6, a further embodiment is disclosed. The difference between this embodiment and the embodiment shown in FIG. 1 is in that the present invention has no basic input output system 25. When users send a remote signal through the input unit 20, refer to step S21, the remote signal is received by the computer system. Then as shown in step S22, the first extensible firmware interface 30 is initiated directly to drive necessary hardware equipment 50. Then refer to step S23, judge whether the remote signal is for executing the multimedia player system 40 by the first extensible firmware interface 30. If yes, continue step S24, the second operating system 14 and the multimedia player system 40 are executed. If not, jump to step S25, the second extensible firmware interface 35 is initiated, the first operating system 10 is executed, and all hardware equipment 50 is driven.

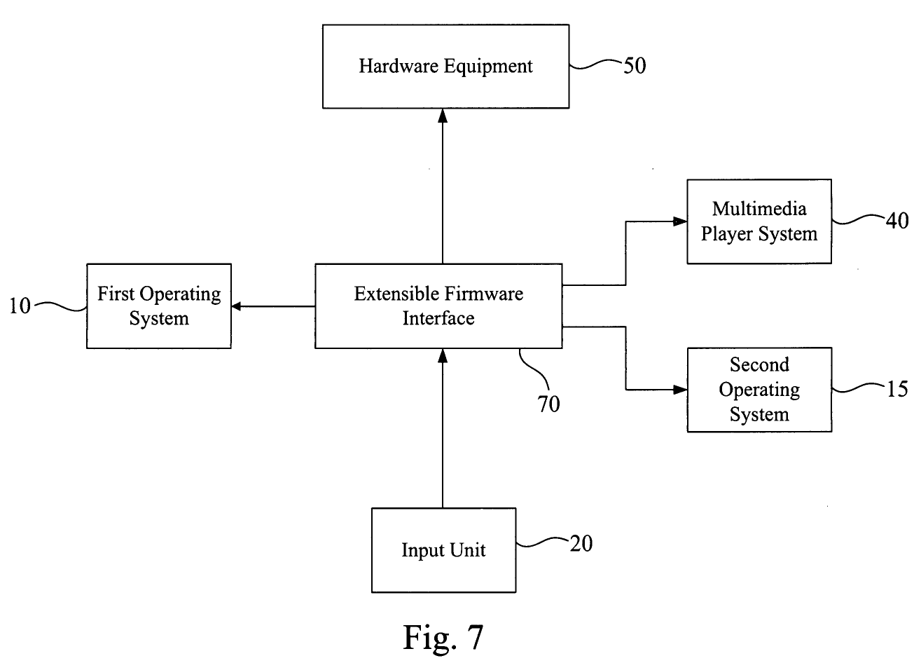

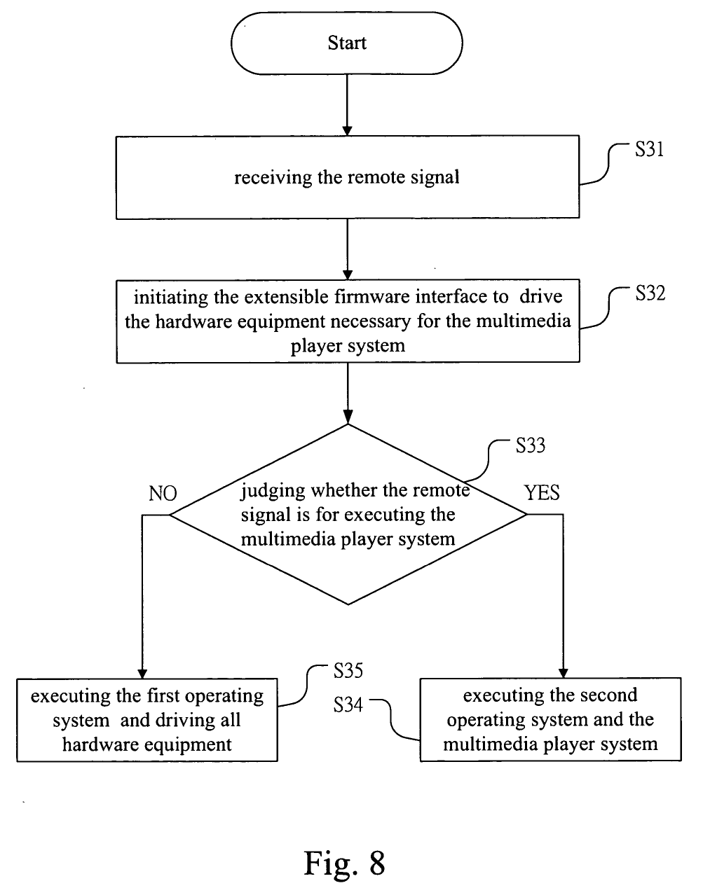

Refer to FIG. 7 & FIG. 8, a further embodiment is disclosed. The difference between this embodiment and the embodiment shown in FIG. 1 is in that the present invention includes an extensible firmware interface 70, instead of the basic input output system 25, the first extensible firmware interface 30, and the second extensible firmware interface 35 in the embodiment in FIG. 1. Through the input unit 20, users transmit a remote signal and as shown in step S31, the computer system receives the remote signal. Refer to step S32, the extensible firmware interface 70 is initiated to drive necessary hardware equipment 50. Then as shown in step S33, judge whether the remote signal is for executing the multimedia player system 40. If yes, refer to step S34, the second operating system 15 and the multimedia player system 40 are executed. On the contrary, if not, jump to step S35, the extensible firmware interface 70 executes the first operating system 10 and drives all hardware equipment 50.

In summary, the present invention provides a computer system for executing multimedia player system and the method thereof. When users want to initiate the multimedia player system 40, they only need to send a remote signal to the computer system through the input unit 20 so as to initiate the extensible firmware interface for driving the necessary hardware equipment 50. Also the second operating system 15 and the multimedia player system 40 are executed. Thus it's easy and convenient for users to operate the computer system. There is not need to drive all hardware equipment 50 of the computer system to avoid waste of power.

Moreover, the multimedia player system 40 is initiated under the second operating system 15 in the present invention so that the initiating time is reduced and the efficiency is raised.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

1. A computer system for executing multimedia player system comprising:
a first operating system;
a second operating system with lower system resource consumption than the system resource consumption of the first operating system;
a multimedia player system for executing at least one multimedia operation;
an extensible firmware interface for driving a plurality of necessary hardware equipment of the computer system while executing the multimedia player system; and
a basic input output system for initiating the extensible firmware interface;
wherein a remote signal is sent by an input unit to initiate the basic input output system for initiating the extensible firmware interface and driving the necessary hardware equipment; by judging the remote signal, the basic input output system or the extensible firmware interface executes the second operating system as well as the multimedia player system or the first operating system; while executing the first operating system, the extensible firmware interface drives all of a plurality of hardware equipment of the computer system.

2. The computer system for executing multimedia player system as claimed in claim 1, wherein the remote signal is judged by the basic input output system.

3. The computer system for executing multimedia player system as claimed in claim 1, wherein the remote signal is judged by the extensible firmware interface.

4. The computer system for executing multimedia player system as claimed in claim 1, wherein the first operating system is a Windows operating system.

5. The computer system for executing multimedia player system as claimed in claim 1, wherein the second operating system is a Linux operating system.

6. The computer system for executing multimedia player system as claimed in claim 1, wherein the multimedia player system plays MPEG-1 Audio Layer 3 (MP3) music, compact disk (CD), digital versatile disc (DVD), Video Compact Disc (VCD), TV programs, broadcasting or digital photographs.

7. The computer system for executing multimedia player system as claimed in claim 1, wherein the input unit is a remote controller.

8. The computer system for executing multimedia player system as claimed in claim 1, wherein the extensible firmware interface further having a first extensible firmware interface and a second extensible firmware interface; the first extensible firmware interface is for driving the necessary hardware equipment of the computer system when executes the multimedia player system, or executing the second operating system as well as the multimedia player system while the second extensible firmware interface is for driving all of hardware equipment of the computer system or executing the first operating system.

9. A method for executing multimedia player system applied to a computer system installed with a multimedia player system, a first operating system and a second operating system with lower system resource consumption than the system resource consumption of the first operating system comprising the steps of:
receiving a remote signal by the computer system;
initiating a basic input output system of the computer system;
initiating an extensible firmware interface for driving a plurality of necessary hardware equipment of the computer system while executing the multimedia player system; and
judging the remote signal being a signal for executing the multimedia player system and then executing the second operating system as well as the multimedia player system;
wherein judging the remote signal is not a signal for executing the multimedia player system then executing the first operating system and driving all of a plurality of hardware equipment of the computer system.

10. The method for executing multimedia player system as claimed in claim 9, wherein the step of judging the remote signal is run by the basic input output system.

11. The method for executing multimedia player system as claimed in claim 9, wherein the step of judging the remote signal is run by the extensible firmware interface.

12. The method for executing multimedia player system as claimed in claim 9, wherein the first operating system is a Windows operating system.

13. The method for executing multimedia player system as claimed in claim 9, wherein the second operating system is a Linux operating system.

14. The method for executing multimedia player system as claimed in claim 9, wherein the multimedia player system plays MPEG-1 Audio Layer 3 (MP3) music, compact disk (CD), digital versatile disc (DVD), Video Compact Disc (VCD), TV programs, broadcasting or digital photographs.

15. The method for executing multimedia player system as claimed in claim 9, wherein on step of initiating an extensible firmware interface, the extensible firmware interface being initiated is a first extensible firmware interface of the extensible firmware interface.

16. The method for executing multimedia player system as claimed in claim 9, wherein the step of judging the remote signal not a signal for executing the multimedia player system, then executing the first operating system and driving all of a plurality of hardware equipment of the computer system further comprising the step of: initiating a second extensible firmware interface of the extensible firmware interface to drive all of a plurality of hardware equipment of the computer system.

17. A computer system for executing multimedia player system comprising:
a first operating system;
a second operating system with lower system resource consumption than the system resource consumption of the first operating system;
a multimedia player system for executing at least one multimedia operation; and
an extensible firmware interface for driving a plurality of necessary hardware equipment of the computer system while executing the multimedia player system;
wherein a remote signal is sent by an input unit to initiate the extensible firmware interface and drive the necessary hardware equipment; according to the remote signal, the second operating system as well as the multimedia player system or the first operating system are executed; while executing the first operating system, the extensible firmware interface drives all of a plurality of hardware equipment of the computer system.

18. The computer system for executing multimedia player system as claimed in claim 17, wherein the first operating system is a Windows operating system.

19. The computer system for executing multimedia player system as claimed in claim 17, wherein the second operating system is a Linux operating system.

20. The computer system for executing multimedia player system as claimed in claim 17, wherein the multimedia player system plays MPEG-1 Audio Layer 3 (MP3) music, compact disk (CD), digital versatile disc (DVD), Video Compact Disc (VCD), TV programs, broadcasting or digital photographs.

21. The computer system for executing multimedia player system as claimed in claim 17, wherein the input unit is a remote controller.

22. The computer system for executing multimedia player system as claimed in claim 17, wherein the extensible firmware interface further having a first extensible firmware interface and a second extensible firmware interface; the first extensible firmware interface is for driving the necessary hardware equipment of the computer system when executes the multimedia player system, and executing the second operating system as well as the multimedia player system while the second extensible firmware interface is for driving all of hardware equipment of the computer system and executing the first operating system.

23. A method for executing multimedia player system applied to a computer system installed with a multimedia player system, a first operating system and a second operating system with lower system resource consumption than the system resource consumption of the first operating system comprising the steps of:
receiving a remote signal by the computer system;
initiating an extensible firmware interface for driving a plurality of necessary hardware equipment of the computer system while executing the multimedia player system; and
judging the remote signal being a signal for executing the multimedia player system and then executing the second operating system and the multimedia player system;
wherein judging the remote signal is not a signal for executing the multimedia player system then executing the first operating system and driving all of a plurality of hardware equipment of the computer system.

24. The method for executing multimedia player system as claimed in claim 23, wherein the first operating system is a Windows operating system.

25. The method for executing multimedia player system as claimed in claim 23, wherein the second operating system is a Linux operating system.

26. The method for executing multimedia player system as claimed in claim 23, wherein the multimedia player system plays MPEG-1 Audio Layer 3 (MP3) music, compact disk (CD), digital versatile disc (DVD), Video Compact Disc (VCD), TV programs, broadcasting or digital photographs.

27. The method for executing multimedia player system as claimed in claim 23, wherein on step of initiating an extensible firmware interface, the extensible firmware interface being initiated is a first extensible firmware interface of the extensible firmware interface.

28. The method for executing multimedia player system as claimed in claim 23, wherein the step of judging the remote signal not a signal for executing the multimedia player system, then executing the first operating system and driving all of a plurality of hardware equipment of the computer system further comprising the step of: initiating a second extensible firmware interface of the extensible firmware interface to drive all of a plurality of hardware equipment of the computer system as well as execute the first operating system.
